(19) United States
(12) Patent Application Publication
(10) Pub. No.: US 2004/0148388 A1
(43) Pub. Date: Jul. 29, 2004

(54) Protocol at layer two for discovering and configuring network devices

(76) Inventors: Wen-Tzu Chung, Hsinchu (TW); Kun-Hsiao Li, Hsinchu (TW)

Correspondence Address: SUPREME PATENT SERVICES, POST OFFICE BOX 2339, SARATOGA, CA, 95070, US

(21) Appl. No.: 10/351,414

(22) Filed: Jan. 24, 2003

(51) Int. Cl. G06F 15/173

(52) U.S. Cl. 709/224

(57) ABSTRACT

A proprietary packet based on a standard IEEE 802.3 packet is used to discover and configure a layer 2 network device. The proprietary packet has a packet length field filled with an illegal length 0x3842. The proprietary packet is generally ignored because of its illegal length. A network equipped with a proprietary protocol recognizes the illegal length as the identification of the proprietary packet, interprets the packet and responds with its MAC address, subnet mask and the default gateway's IP address. By means of the proprietary packets having the illegal length 0x3842, a proprietary handshake protocol is established between a PC and network devices connected to an Ethernet hub for discovering and configuring the network devices.

### FIELD OF THE INVENTION

The present invention generally relates to the configuration of network devices and more specifically to a protocol at MAC layer for discovering and configuring network devices.

### BACKGROUND OF THE INVENTION

A network bridge device is usually classified as a layer #2 device. A bridge device is used to transmit packets from in-bound to out-bound bi-directionally. In general the configuration for a bridge device is not required. An IEEE802.11 compliant Access Point basically is a bridge device. It transmits the packet from IEEE802.3 Ethernet to IEEE802.11 Wireless LAN bi-directionally. However, in order to make the Access Point operational, minimum configuration such as SSID, Radio Channel, and WEP security key is required.

There are many ways in managing a bridge device. The most common one is either Web base management or SNMP. Both of them are applications based on the transport layer which is one layer above the IP layer. Web base management is based on TCP protocol. Likewise, SNMP is based on UDP protocol. Internet protocol is contained in layer #3. The fundamental constraint of Internet protocol is that the bridge's IP address and the IP address of the PC used for configuring has to be located within the same subnet. Under this condition the management function can be applied.

The above-mentioned constraint that IP addresses have to be in the same subnet creates a few problems. One problem is that although a user can easily configure the bridge with its factory default IP address, the user has to memorize the new IP address very carefully once it is changed. If the new IP address is forgotten, one can no longer configure the bridge device except by loading the factory default setting back again.

Another problem attributes to the fact that a wireless router has a DHCP server. It can allocate an IP address to the PC (DHCP client) used for the configuration. However, as to the application with the presence of many Access Points, it will be very difficult to manage if each Access Point has a DHCP server.

The bridge device can also provide a USB port or an RS232 serial port for the management purpose. It can avoid the constraint of the Internet Protocol via a direct access. However, usually the configuration for the bridge is only done at the very first time. The possibility of the 2nd time configuration is very little. It is not worthwhile to provide the additional hardware for this very infrequently used function. The ideal way is to use the existing hardware for the normal operation to achieve the configuration purpose as well.

### SUMMARY OF THE INVENTION

This invention has been made to overcome the above-mentioned drawbacks in managing a network bridge device. The primary object of the invention is to provide a method for managing a bridge device with an existing IEEE 802.3 ethernet port or IEEE 802.11 wireless LAN radio. Accordingly, a proprietary packet based on IEEE 802.3 standard with an illegal length is used to establish a proprietary handshake protocol of the invention.

The proprietary packet of this invention contains x3842 as its length for the packet identification. Because it is an illegal Ethernet packet, it is normally ignored by manageable network devices. Based on the proprietary packet described above, a new device discovery protocol of this invention is accomplished by sending an inquiry packet from a PC used for the configuration purpose to all the network bridge devices connected together via an Ethernet hub. The network bridge devices built in with the proprietary protocol automatically respond with their IP address, subnet mask and default gateway respectively.

A special utility program running at the Window based PC is used to view the IP address, subnet mask, and default gateway reported from the bridge devices. The utility program also allows a user to modify the IP address, subnet mask, and default gateway of each individual bridge device so that the IP address of the bridge can be changed to the same subnet as that of the PC used for the configuration purpose.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1A shows a standard IEEE 802.3 packet.

FIG. 1B shows a proprietary packet format according to the present invention.

FIG. 2A shows the content of a proprietary packet sent by the PC used for configuration to all network bridge devices according to the present invention.

FIG. 2B shows the content of a proprietary packet responded by a network bridge device to the PC used for configuration according to the present invention.

### DETAILED DESCRIPTION OF THE PREFERRED EMBODIMENTS

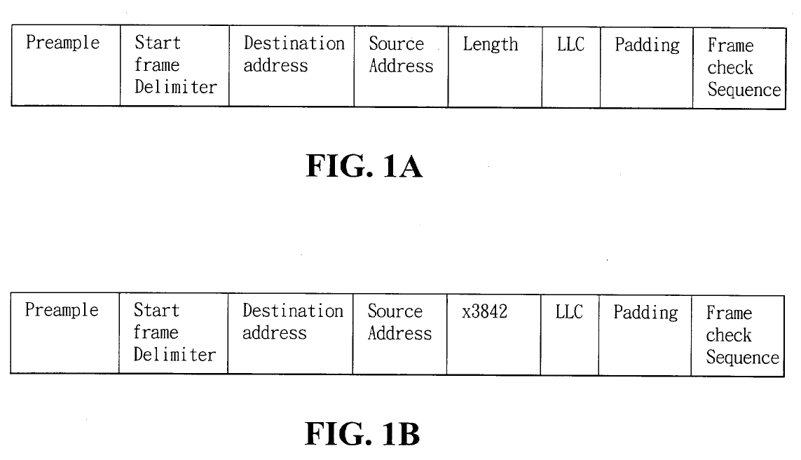

The present invention discloses a new way to manage a bridge device with an existing IEEE 802.3 Ethernet port or IEEE 802.11 wireless LAN radio. FIG. 1A shows a standard IEEE 802.3 packet. The maximum packet length specified by IEEE 802.3 can not exceed 1500 bytes. According to this standard, any packet having length greater than 1500 bytes is illegal.

FIG. 1B shows a proprietary packet according to this invention. In the packet, the field “Length” is used as a unique packet identification of this invention. A hexadecimal value x3842 is used as the identification. Because the packet is an illegal Ethernet packet with this illegal length, all manageable network devices automatically ignore this packet. Only the network device built in with the proprietary protocol of this invention will inspect the content inside the packet. Therefore, command and data can be packed inside this proprietary packet. A proprietary handshake protocol can thus be established as well.

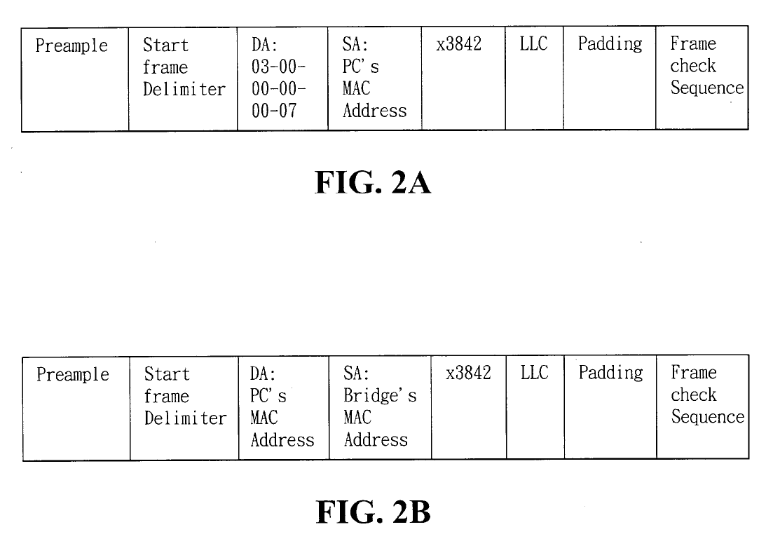

According to this invention, the network bridges and a Window based PC for configuring these devices are connected together via an Ethernet Hub. The proprietary handshake protocol is running within the bridge devices and the PC. Initially, the PC is not aware of the MAC address of each network bridge device. It sends an inquiry packet defined by the format shown in FIG. 1B. The packet contains x3842 as its length for the packet identification. The MAC address of the PC is the source address and the destination address contains 6 bytes with hexadecimal value 03-00-00-00-00-07 (MAC address) as the group identifier. The packet also includes a command for requesting IP address, subnet mask, and default gateway's IP address from all network bridges. FIG. 2A illustrates such a packet.

When the network bridge device receives this unique packet sent from PC, it interprets the packet and responds back with another proprietary packet that also contains x3842 as its length for the packet identification. In the packet, the MAC address of the responding network bridge device is the source address and the 6 byte MAC address of the PC is the destination address. The network bridge device also replies back with its IP address, subnet mask, and default gateway's IP address. FIG. 2B illustrates the proprietary packet responded by a network bridge device.

According to the replied information, the PC used for the configuration purpose sets up a table to store the parameters of each network Bridge. The parameters include MAC address, IP address, subnet mask, and default gateway's IP address. The user can therefore modify these IP addresses, subnet mask, or default gateway's IP address of a network bridge device using a PC's utility program. After the IP addresses, subnet mask, or default gateway's IP address are modified, the PC will send a packet based on the new IP addresses, subnet mask, or default gateway's IP address to the network bridge device to be configured. The packet contains x3842 as its length for the packet identification, the MAC address of the PC as the source address, the MAC address of the specified network bridge device as the destination address, and command for modifying IP address, subnet mask, and default gateway's IP address of the specified network bridge.

The specified network bridge will interpret this command for changing the network setting and executing the changes of IP address, subnet mask, and default gateway's IP address. Once the modification is completed, the network bridge will notify the PC with another proprietary packet with x3842 as its length for the packet identification, its MAC address as the source address, and the 6 byte MAC address of the PC as the destination address. It also replies that the change request for IP address, subnet mask, and default gateway's IP address is effective.

According to the proprietary handshake protocol described above, a new device discovery protocol has been established by the present invention that allows the network management to find all the bridge devices equipped with this proprietary discovery protocol as long as the physical connection of the bridge devices is well established and operational. All the bridge devices being found automatically report its IP address, subnet mask, and default gateway.

As a result, the invention achieves the similar management capability provided by either a USB port or an RS232 port without the actual USB or RS232 device in place. It also avoids the Internet Protocol's constraint caused by the subnet's classification. A special utility program running at a Window based PC is able to view the IP address, subnet mask, and default gateway reported from the bridge device. The utility program also allows a user to modify the IP address, subnet mask, and default gateway of each individual bridge device so that the IP address of the bridge can be changed to the same subnet as that of the PC used for the configuration purpose.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of discovering and configuring a network device, comprising the step of sending a proprietary inquiry packet from a PC to network devices connected to an Ethernet hub, said proprietary inquiry packet being a standard IEEE 802.3 packet having a packet length field filled with a pre-defined value greater than 1500, a source address filled with a MAC address of said PC, a destination address filled with a pre-defined value, and a command for requesting an IP address, a subnet mask and a default gateway's IP address.

2. The method of discovering and configuring a network device as claimed in claim 1, wherein said pre-defined value for said packet length field in said proprietary inquiry packet is a hexadecimal number 0x3842, and said pre-defined value for said destination address is a 6 byte hexadecimal value 0x030000000007.

3. The method of discovering and configuring a network device as claimed in claim 1, wherein a network device connected on said Ethernet hub replies to said PC with a proprietary response packet, said proprietary response packet being a standard IEEE 802.3 packet having a packet length field filled with a pre-defined value greater than 1500, a source address filled with a MAC address of said network device, a destination address filled with the MAC address of said PC, and a reply including an IP address, a subnet mask and a default gateway's IP address of said network device.

4. The method of discovering and configuring a network device as claimed in claim 3, wherein said pre-defined value for said packet length field in said proprietary response packet is a hexadecimal number 0x3842.

5. The method of discovering and configuring a network device as claimed in claim 3, wherein said PC sets up a table for storing network parameters including MAC address, IP address, subnet mask and default gateway's IP address for each network device.

6. The method of discovering and configuring a network device as claimed in claim 5, wherein said PC includes a utility program for modifying network parameters for each network device.

7. The method of discovering and configuring a network device as claimed in claim 6, wherein said PC sends a proprietary configuration packet to a specified network device connected to said Ethernet hub after a user has modified the network parameters for said specified network device, said proprietary configuration packet being a standard IEEE 802.3 packet having a packet length field filled with a pre-defined value greater than 1500, a source address filled with the MAC address of said PC, a destination address filled with a MAC address of said specified network device, and a configuration command with an IP address, a subnet mask and a default gateway's IP address of said specified network device.

8. The method of discovering and configuring a network device as claimed in claim 7, said pre-defined value for said packet length field in said proprietary configuration packet is a hexadecimal number 0x3842.

9. The method of discovering and configuring a network device as claimed in claim 7, wherein said specified network device replies to said PC with a proprietary acknowledge packet, said proprietary acknowledge packet being a standard IEEE 802.3 packet having a packet length field filled with a pre-defined value greater than 1500, a source address filled with the MAC address of said specified network device, a destination address filled with the MAC address of said PC, and an acknowledge to said configuration command.

10. The method of discovering and configuring a network device as claimed in claim 9, wherein said pre-defined value for said packet length field in said proprietary acknowledge packet is a hexadecimal number 0x3842.
